(19) United States
(12) Patent Application Publication
(10) Pub. No.: US 2009/0009809 A1
(43) Pub. Date: Jan. 8, 2009

(54) Image forming apparatus and job information management method

(75) Inventor: Koji Kita, Machida-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolt Business Technologies, Inc., Chiyoda-ku (JP)

(21) Appl. No.: 12/073,863

(22) Filed: Mar. 11, 2008

(30) Foreign Application Priority Data
Jun. 7, 2007 (JP) 2007-151586

(51) Int. Cl. G06K 15/00

(52) U.S. Cl. 358/1.16

(57) ABSTRACT

Disclosed is an image forming apparatus, including: a first storage section to store a job information item of a job whose execution has been completed; a nonvolatile second storage section having a larger capacity for storing the job information item than the first storage section; and a control section to store the job information item into the first storage section and the second storage section to manage the job information item.

### BACKGROUND OF THE INVENTION

1. Field of the Invention

The present invention relates to an image forming apparatus and a job information management method.

2. Description of Related Art

There has been recently known an image forming apparatus such as a printer, a facsimile, a copying machine, MFP (Multi Function Peripheral) having various functions. such as an image forming function, a copying function, a scan function, a facsimile function, etc. of the above machines, or the like.

Information of jobs executed by an image forming apparatus (hereinafter referred to “job information”) is managed for the purpose of storing job information of a job whose execution has been completed into a memory, tabulating the job information according to an application specified by a user or a predetermined item, and displaying the tabulated result or a history of the job information.

For example, JP-A-2004-178325 discloses a job account server which manages job information outputted to printers from a client computer. In the job account server, at first, a tabulation item for tabulating job information is set, and job information is obtained from job information recorded in a job log recording section based on the tabulation item. Then, history information included in the obtained job information is tabulated, and the tabulated result of the tabulated history information is outputted to the client computer.

According to JP-A-2004-178325, the job information is stored in an external device which is provided outside the image forming apparatus, and the external device manages the job information. Therefore, the job information is transmitted/received between the image forming apparatus and the external device. Accordingly, depending on a communication state, a storage standby state may occur because the job information may not be stored in the memory, or a reading-out standby state may occur because the job information may not be read out from the memory. Hence, the communication speed in storing the job information into the memory may be reduced, and this could lead to an unstable state.

Even if the job information is stored in the memory of the image forming apparatus instead of storing the job information in the external device, pieces of job information are deleted beginning with the chronologically oldest job information because the storage capacity of the memory is limited. If the memory is a volatile memory, the job information stored in the memory is erased when the power is off.

### SUMMARY OF THE INVENTION

It is, therefore, a main object of the present invention to provide an image forming apparatus and a job information managing method capable of enhancing a management function of the job information by preventing speed of reading and writing the job information from being reduced and by storing a large amount of job information.

To achieve at least one of the above objects, an image processing apparatus reflecting a first aspect of the present invention comprises: a first storage section to store a job information item of a job whose execution has been completed; a nonvolatile second storage section having a larger capacity for storing the job information item than the first storage section; and a control section to store the job information item into the first storage section and the second storage section to manage the job information item.

According to a second aspect of the present invention, there is provided a management method of job information in an image forming apparatus including a first storage section having a first storage area and a second storage area and a nonvolatile second storage section having a larger capacity than the first storage section, the management method, comprising: generating a job information item which is a history data item of a job; storing the job information item into the first storage area and the second storage area; and storing periodically the job information item stored in the second storage area into the second storage section.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram showing a configuration of an image forming apparatus according to embodiments of the present invention;

FIG. 2 is a diagram showing a configuration of a RAM of the image forming apparatus;

FIG. 3 is a diagram showing an example of a first job history display screen;

FIG. 4 is a diagram showing an example of a second job history display screen;

FIG. 5 is a flowchart showing a job history data storage processing carried out when execution of a job is completed;

FIG. 6 is a flowchart showing a job history data storage processing which stores job history data stored in an intermediate buffer into HDD; and

FIG. 7 is a flowchart showing a job history data display processing.

### DESCRIPTION OF THE PREFERRED EMBODIMENTS

Preferred embodiments of the present invention will be described with reference to the drawings.

First, a configuration in the present embodiments will be described below.

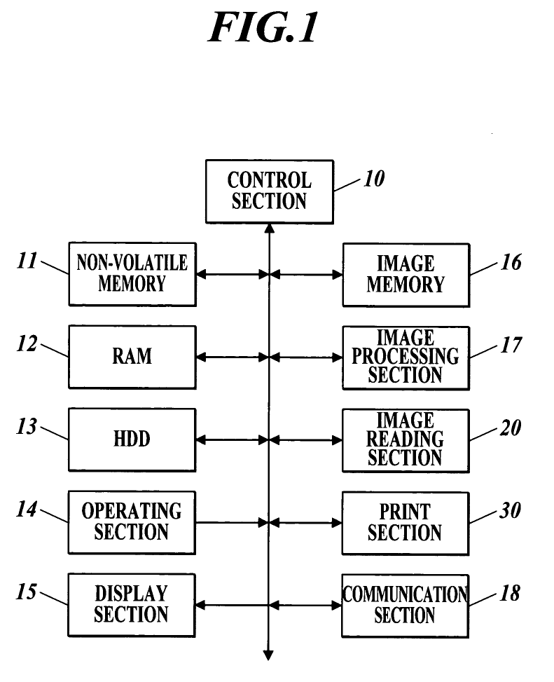

FIG. 1 shows a configuration diagram of an image forming apparatus according to the present embodiments.

As shown in FIG. 1, the image forming apparatus includes a control section 10, a nonvolatile memory 11, a RAM (Random Access Memory) 12, a HDD (Hard Disc Drive) 13, an operating section 14, a display section 15, an image memory 16, an image processing section 17, a communication section 18, an image reading section 20, a print section 30, etc., and these sections are electrically connected to one another.

The control section 10 includes a CPU (Central Processing Unit), etc., loads a system program, various kinds of control programs and various kinds of data stored in the nonvolatile memory 11 into RAM 12, and controls the respective sections constituting the image forming apparatus in cooperation with these programs and the data.

Furthermore, the control section 10 executes a job history data storage processing for storing into RAM 12 and HDD 13 a job information item of a job whose execution has been completed (hereinafter referred to as a “job history data item”), and a job history data display processing for displaying the job history data item on the display section 15 according to an instruction from the operating section 14. The control section 10 functions as a control section for managing the job history data.

In the job history data storage processing, in order to store the job history data item into HDD 13, the control section 10 temporarily stores one or more job history data items into an intermediate buffer as a second storage area (described later) in RAM 12, and periodically store the one or more job history data items stored in the intermediate buffer into HDD 13.

In the job history data display processing, when accepting an instruction for displaying the one or more job history data items stored in HDD 13 on the display section 15 by the operating section 14, the control section 10 stores the one or more job history data items stored in the intermediate buffer into HDD 13, and stores the number (N) of job history data items stored in a job history managing area as a first storage area (described later) in RAM 12. Then, the control section 10 reads out one or more job history data items stored in HDD 13 on the basis of a preset condition, stores the one or more job history data items into the job history managing area, and controls the display section 15 to display the one or more job history data items stored in the job history managing area. When the display of the one or more job history data items stored in HDD 13 is finished, the control section 10 stores N job information items, which are read out from latest job information items out of the job information items stored in HDD 13, into the job history managing area. This allows the job history managing area to return to the state before job data stored in the HDD 13 is displayed on the display section 15.

The nonvolatile memory 11 includes a nonvolatile memory such as a ROM (Read Only Memory), a HDD or the like, and stores the system program, various kinds of control programs, programs for the job history data storage processing and the job history data display processing executed by the control section 10, and data associated with these programs, etc.

The RAM 12 provides a working area for temporarily storing various kinds of programs executed by the control section 10 and data associated with these programs. The RAM 12 includes a reserved job managing area 12a, a job history managing area 12b and an intermediate buffer 12c. The RAM 12 stores job data of a job whose execution has been completed as a job history data item. The RAM 12 functions as a first storage section which has a higher speed of writing and reading the job history data item than the HDD 13.

A memory having a higher speed of writing and reading a job history data item than the second storage section (the HDD 13 in the present embodiments) may be used as the first storage section instead of the RAM 12.

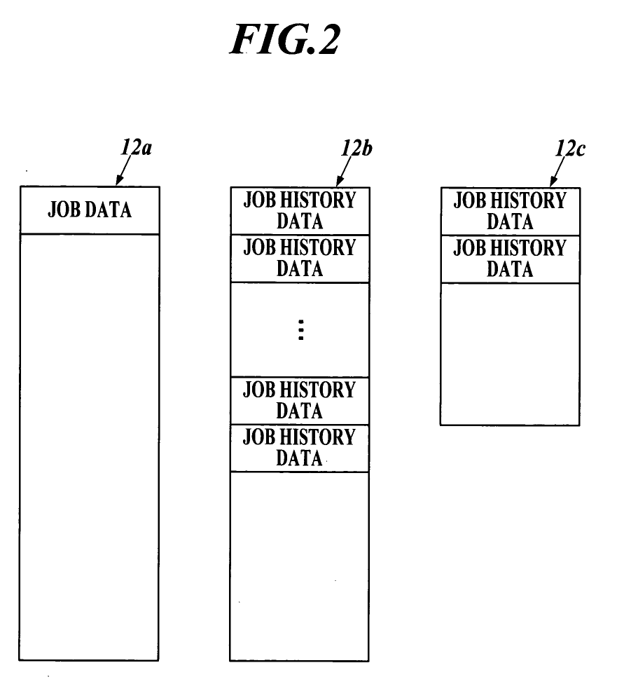

FIG. 2 shows a configuration of the RAM 12.

As shown in FIG. 2, the RAM 12 includes a reserved job managing area 12a, a job history managing area 12b and an intermediate buffer 12c.

The reserved job managing area 12a is a preset area in the RAM 12. A job data item of a reserved job whose execution has not been completed is stored in this reserved job managing area 12a.

The job history managing area 12b is a preset area in the RAM 12. A job data item of a job whose execution has been completed is stored as a job history data item in this area. The job history managing area 12b corresponds to the first storage area.

The intermediate buffer 12c is a preset area in the RAM 12, and is smaller in capacity than the job history managing area 12b. A preset number of job history data items to be stored into the HDD 13 can be temporarily stored in the intermediate buffer 12c. The intermediate buffer 12c corresponds to the second storage area.

The HDD 13 functions as the nonvolatile second storage section having a larger capacity for storing the job history data item than the RAM 12.

A nonvolatile memory having a larger capacity than the first storage section (the RAM 12 in the present embodiments) may be used as the second storage section instead of the HDD 13.

The operating section 14 includes various kinds of operating hard keys such as a copy start key, ten keys, etc., and outputs operation signals of these operating hard keys to the control section 10. The operating section 14 includes a touch panel provided so as to cover a LCD of the display section 15. The touch panel detects a touch-indicated coordinate by a coordinate reading principle such as an electromagnetic induction type, a magnetostriction type, a pressure-sensitive type or the like, and outputs the detected coordinate to the control section 10. The operating section 14 functions as an input section for accepting an instruction on a screen of the display section 15 to display one or more job history data items stored in the RAM 12 or the HDD 13.

The display section 15 includes a display screen such as a LCD (Liquid Crystal Display) or the like, a VRAM (Video Random access Memory) for temporarily storing data for displaying an operation screen on the display screen, etc. The display section 15 displays various kinds of screens according to data written in the VRAM by the control section 10. The display section 15 functions as a display section for displaying, on the display screen, a first job history display screen G1 and a second job history display screen G2 for showing a job history data item according to an instruction from the control section 10.

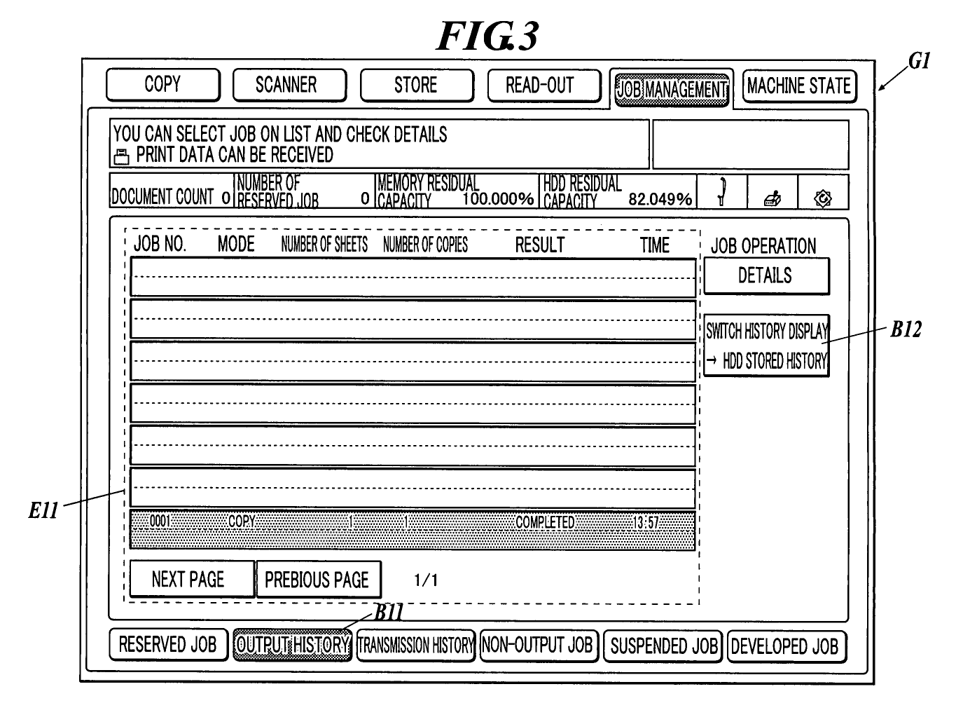

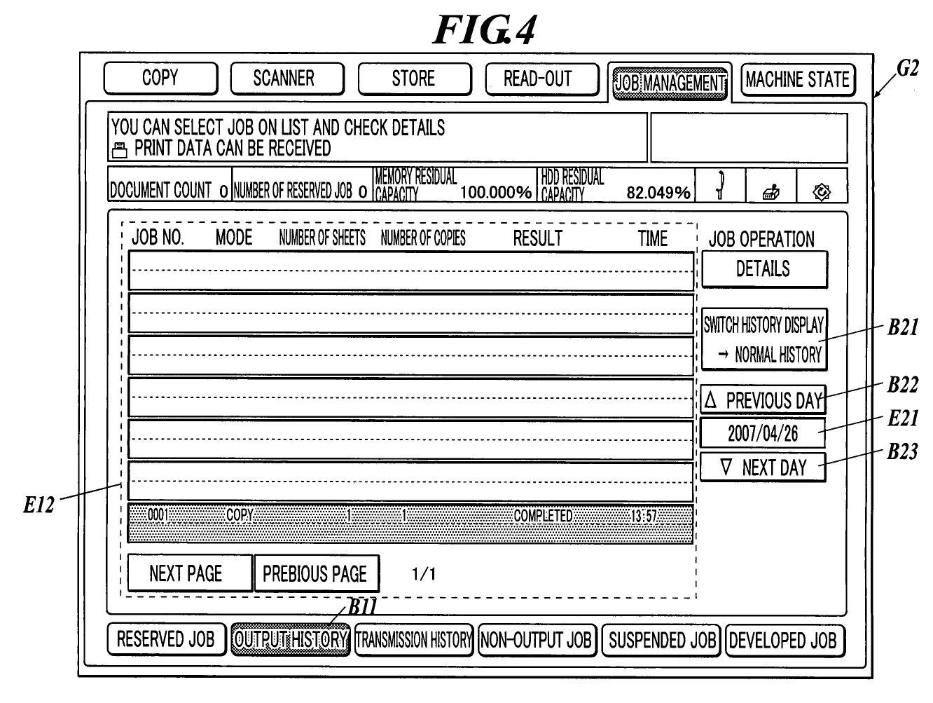

FIG. 3 shows an example of the first job history display screen G1, and FIG. 4 shows an example of the second job history display screen G2.

As shown in FIG. 3, the first job history display screen G1 has an output history button B11, a history display switching button B12, a job history display area E11, etc.

The output history button B11 is a button for accepting an instruction for displaying a job history data item of a job whose execution has been completed on the job history display area E11.

The history display switching button B12 is a button for accepting an instruction for displaying the second job history display screen G2 by switching from one or more job history data items shown in the job history display area E11 to one or more job history data items stored in the HDD 13. The one or more job history data items shown in the job history display area E11 on the first job history display screen G1 is stored in the job history managing area 12b of the RAM 12.

As shown in FIG. 4, the second job history display screen G2 has the same output history button B11 as the first job history display screen G1, a job history display area E11, a history display switching button B21, a date display area E21, a previous day button B22, a next day button B23, etc.

The history display switching button B21 is a button for accepting an instruction for displaying the first job history display screen G1 by switching from one or more job history data items shown in the job history display area E12 to one or more job history data items stored in the job history managing area 12b of the RAM 12. The one or more job history data items shown in the job history display area E12 on the second job history display screen G2 is stored in the HDD 13.

The date display area E21 shows the date of the one or more job history data item displayed in the job history display area E11. The previous day button B22 is a button for accepting an instruction for displaying one or more job history data items which are stored in the HDD 13 on the previous day of the date displayed in the date display area E21. The next day button B23 is a button for accepting an instruction for displaying one or more job history data items which are stored in the HDD 13 on the next day of the date displayed in the date display area E21.

As shown in FIGS. 3 and 4, each of the job history data items includes information such as a job No., a mode of the job, the number of pages, the number of copies, a job result indicating whether the job is properly executed or not, the time at which the job is executed, etc.

The image memory 16 is comprised of a DRAM (Dynamic RAM), and includes a compression memory for temporarily storing compressed image data, and a page memory for temporarily storing non-compressed image data to be printed before printing.

The image processing section 17 compresses image data outputted from the image reading section 20 or image data transmitted through the communication section 18 on the basis of an instruction from the control section 10, and writes and temporarily stores these compressed image data in the compression memory of the image memory 16.

The communication section 18 includes various kinds of interfaces such as NIC, a modem, USB, etc., and mutually transmits/receives information to/from an external device on a network.

The image reading section 20 includes a light source, a photoelectric conversion element such as a CCD (Charge Coupled Devices), etc. at the lower side of a contact glass. The image reading section 20 optically scans a document placed on the contact glass, photoelectrically coverts reflection light from the document by the CCD, and then conducts digital conversion to obtain image data of the document.

The print section 30 includes a paper feeding section (not shown) for feeding various kinds of sheets, and forms an image on an sheet on the basis of image data stored in a page memory in accordance with an print instruction by the control section 10. Any image forming method such as an electrophotographic method, an ink jetting method or the like may be used.

Next, an operation of the present embodiments will be described.

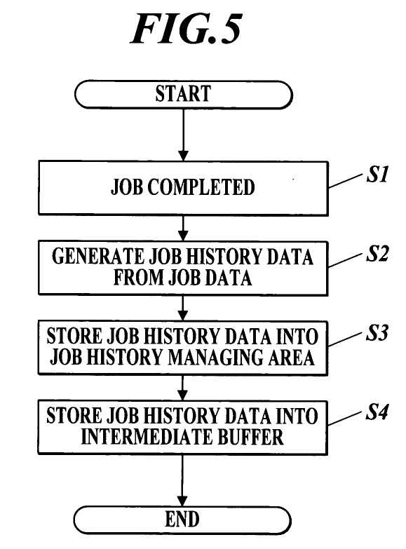

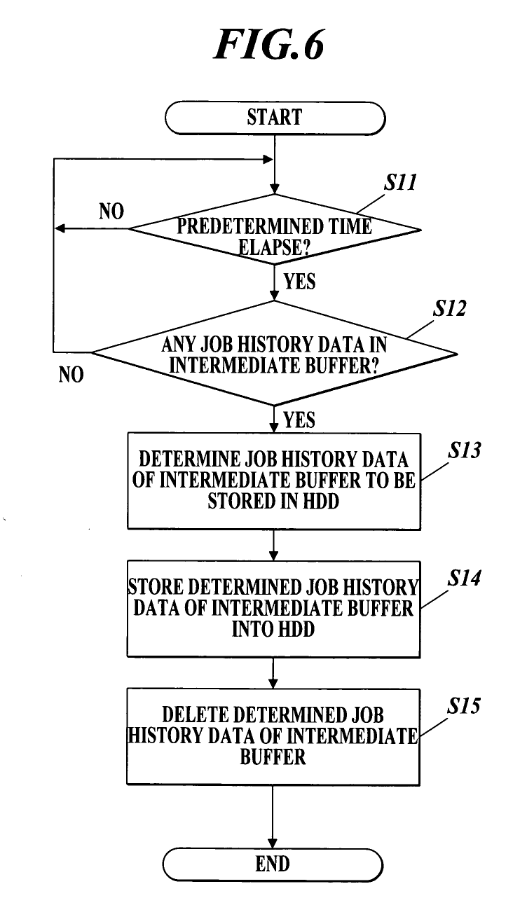

FIGS. 5 and 6 show flowcharts of the job history data storage processing in the present embodiments. FIG. 5 shows the processing carried out when execution of a job is completed, and FIG. 6 shows the processing of storing one or more job history data items stored in the intermediate buffer 12c into the HDD 13.

The processing shown in FIGS. 5 and 6 is carried out in cooperation with the control section 10, the program of the job history data storage processing stored in the nonvolatile memory 11, the RAM 12 and the HDD 13.

As shown in FIG. 5, when execution of a job is completed (step S1), the control section 10 generates a job history data item from data of the job whose execution has been completed (step S2).

Then, the control section 10 stores the generated job history data item into the job history managing area 12b in the RAM 12 (step S3), and also stores a copy of the job history data item into the intermediate buffer 12c (step S4), thereby finishing this processing.

As show in FIG. 6, when executing the processing of storing one ore more job history data items stored in the intermediate buffer 12c into the HDD 13, the control section 10 first judges whether a preset time (a predetermined time) elapses from the previous time when one or more job history data items stored in the intermediate buffer 12c is stored into the HDD 13 (step S11).

This predetermined time is set on the basis of the shortest time interval at which a job history data item is generated and the number of job history data items storable in the intermediate buffer 12c so as not to cause a state that a job history data item cannot be stored in the intermediate buffer 12c.

When the predetermined time does not elapse (step S11; No), the control section 10 waits until the predetermined time elapses (return to step S11).

When the predetermined time elapses (step S11; Yes), the control section 10 judges whether one or more job history data items exist in the intermediate buffer 12c (step S12). If there is no job history data item in the intermediate buffer 12c (step S12; No), the processing returns to step S11.

On the other hand, if there are one or more job history data items in the intermediate buffer 12c (step S12; Yes), the control section 10 determines the one or more job history data items stored in the intermediate buffer 12c when the predetermined time elapses as data to be stored in the HDD 13 (step S13).

The control section 10 generates a copy of the one or more job history data items determined in step S13, and stores the copied data items into the HDD 13 (step S14).

The control section 10 deleted the one or more job history data items determined in step S13 in the intermediate buffer 12c (step S15), and then the processing is finished

In this way, the processing shown in FIG. 6 is executed every time the predetermined time elapses, that is, the processing is repeated periodically.

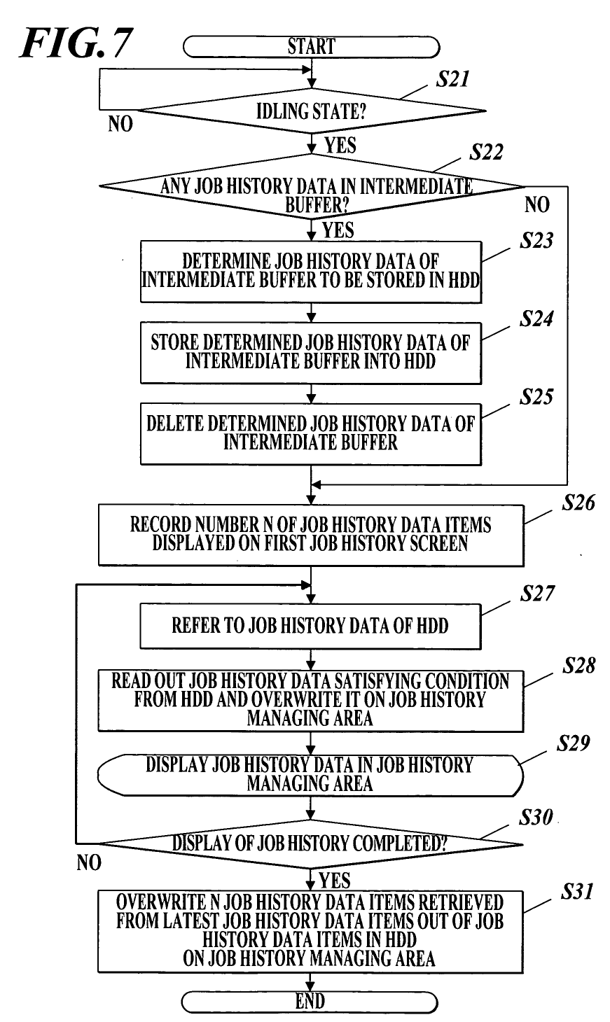

FIG. 7 shows a flowchart of the job history data display processing in the present embodiments.

The processing shown in FIG. 7 is carried out in cooperation with the control section 10, the program of the job history data display processing stored in the nonvolatile memory 11, the RAM 12 and the HDD 13.

When the history display switching button B12 of the first job history display screen Gi displayed on the display section 15 is pushed, the control section 10 judges whether the image forming apparatus is under an idling state or not (step S21). If the image forming apparatus is not in the idling state (step S21; No), the control section 10 waits until the image forming apparatus is in the idling state.

When the image forming apparatus is in the idling state (step S21; Yes), the control section 10 judges whether there are one or more job history data items in the intermediate buffer 12c (step S22) . If there is no job history data item (step S22; No), the processing goes to step S26.

If there are one or more job history data items in the intermediate buffer 12c (step S22; Yes), the control section 10 determines the one or more job history data items stored in the intermediate buffer 12c as data to be stored into the HDD 13 (step S23).

The control section 10 generates a copy of the one or more job history data items determined in step S23, and stores the copied job history data items into the HDD 13 (step S24).

The control section 10 deletes the one or more job history data items determined in step S23 in the intermediate buffer 12c (step S25).

By carrying out the steps S22 to S25, job history data items of all jobs whose execution has been completed are stored into the HDD 13 until the image forming apparatus is in the idling state.

After the step S22: No or after the step S25, the control section 10 stores the number N of job history data items shown in the job history display area E11 of the first job history display screen G1, that is, the number of job history data items stored in the job history managing area 12b of the RAM 12 (step S26).

After the step S26, the control section 10 refers to the job history data items stored in the HDD 13 (step S27), reads out one or more job history data items meeting a preset condition from the HDD 13, and generates a copy of the one or more job history data items. Then, the control section 10 overwrites and stores the copy of the read-out one or more job history data items in the job history managing area 12b (step S28).

The control section 10 controls the display section 15 to display the second job history display screen G2 and display the one or more job history data items stored in the job history managing area 12b on the job history display area E12 of the second job history display screen G2 (step S29).

On the basis of the judgment as to whether one of the history display switching button B21, the previous day button B22 and the next day button B23 of the second job history display screen G2 is pushed or not, the control section 10 judges whether the display of the one or more job history data items stored in the HDD 13 is completed or not (step S30).

When the previous day button B22 or the next day button B23 is pushed, that is, when the display of the one or more job history data items stored in the HDD 13 is not completed (step S30; No), the control section 10 returns to step S27.

When the history display switching button B21 is pushed, that is, when the display of the one or more job history data items stored in the HDD 13 is completed (step S30; Yes), the control section 10 reads out N job history data items (the number N is stored instep S26) from job history data items of the latest date out of the one or more job history data items stored in the HDD 13, generates copies of the read-out job history data items, and overwrites and stores the copies of the read-out N job history data items into the job history managing area 12b of the RAM 12 (step S31), thereby finishing this processing.

As described above, according to the present embodiments, because the image forming apparatus includes the RAM 12 for storing job history data items and the nonvolatile HDD 13 having a larger capacity than the RAM 12, it is possible to dually manage the job history data items. In addition, when the stored job history data items are written/read out, the image forming apparatus is not affected by an external device and can keep a fixed operation speed. Furthermore, because a large number of data items can be stored in the HDD 13, it is possible to enhance the management function of the job history data items.

Particularly, when the image forming apparatus executes another processing in parallel, a high-speed operation is required. By temporarily storing one or more job history data items into the intermediate buffer 12c of the RAM 12 which is capable of reading and writing the job history data items at high speed, and periodically storing the one or more job history data items stored in the intermediate buffer 12c into the HDD 13, the writing frequency of job history data items into the HDD 13 can be reduced, and the other processing can be immediately executed.

Furthermore, in order to display the one or more job history data items stored in the HDD 13 by the display section 15, the one or more job history data items are temporarily stored in the job history managing area 12b of the RAM 12 which can perform reading and writing at higher speed than the HDD 13, then the one or more job history data items stored in the job history managing area 12b are displayed. Therefore, the execution speed of the processing after the one or more job history data items are displayed can be higher than the case where the one or more job history data items are directly read out from the HDD 13.

Furthermore, when an instruction for displaying one or more job history data items stored in the HDD 13 is accepted, all the generated job history data items can be stored in the HDD 13. When the display of one or more job history data items stored in the HDD 13 is finished, the job history managing area 12b can be returned to the state before the one or more job history data items stored in the HDD 13 are displayed.

The present invention is not limited to the above-described embodiments. It will be apparent that various changes may be made without departing from the scope of the invention.

According to a first aspect of the preferred embodiments of the present invention, there is provided an image forming apparatus, comprising: a first storage section to store a job information item of a job whose execution has been completed; a nonvolatile second storage section having a larger capacity for storing the job information item than the first storage section; and a control section to store the job information item into the first storage section and the second storage section to manage the job information item.

Since the image forming apparatus includes the first storage section for storing job information items and the nonvolatile second storage section having a larger capacity than the first storage section, the job information items can be dually managed. Furthermore, when the stored job information items are written/read out, the image forming apparatus is not affected by an external device and can keep a fixed operation speed. Furthermore, because a large number of data items can be stored in the second storage section, it is possible to enhance the management function of the job information items.

Preferably, the first storage section has a higher speed of writing and reading the job information item than the second storage section, and includes a first storage area to store the job information item and a second storage area capable of storing a predetermined number of job information items to be stored into the second storage section, and the control section periodically stores one or more job information items stored in the second storage area into the second storage section.

Furthermore, when the image forming apparatus executes another processing in parallel, a high-speed operation is required. By temporarily storing one or more job information items into the second storage area of the first storage section which is capable of reading and writing the job information items at high speed, and periodically storing the one or more job information items stored in the second storage area into the second storage section, the writing frequency of job information items into the second storage section can be reduced, and the other processing can be immediately executed.

Preferably, the image forming apparatus further comprises: a display section to display the one or more job information items; and an input section to accept an instruction for displaying the one or more job information items stored in the second storage section on the display section, wherein when the input section accepts the instruction for displaying the one or more job information items stored in the second storage section, the control section reads out the one or more job information items stored in the second storage section, stores the one or more job information items into the first storage area, and controls the display section to display the one or more job information items stored in the first storage area.

Furthermore, in order to display the one or more job information items stored in the second storage section by the display section, the one or more job information items are temporarily stored in the first storage area of the first storage section which can perform reading and writing at higher speed than the second storage section, then the one or more job information items stored in the first storage area are displayed. Therefore, the execution speed of the processing after the one or more job information items are displayed can be higher than the case where the one or more job information items are directly read out from the second storage section.

Preferably, when the input section accepts the instruction for displaying the one or more job information items stored in the second storage section, the control section stores the one or more job information items stored in the second storage area into the second storage section, stores the number N of job information items stored in the first storage area, and then reads out the one or more job information items stored in the second storage section, and when display of the one or more job information items stored in the second storage section is finished, the control section stores N job information items, which are read out from latest job information items out of the one or more job information items stored in the second storage section, into the first storage area.

Furthermore, when an instruction for displaying one or more job information items stored in the second storage section is accepted, all the generated job information items can be stored in the second storage section. When the display of one or more job information items stored in the second storage section is finished, the first storage area can be returned to the state before the one or more job information items stored in the second storage section are displayed.

Preferably, the one or more job information items include at least one of the number of pages of a job, a job result indicating whether the job is properly executed or not and a time at which the job is executed.

Preferably, the image forming apparatus further comprises a switching section to switch between displaying one or more job information items stored in the first storage section and displaying one or more job information items stored in the second storage section on the display section.

According to a second aspect of the preferred embodiments of the present invention, there is provided a management method of job information in an image forming apparatus including a first storage section having a first storage area and a second storage area and a nonvolatile second storage section having a larger capacity than the first storage section, the management method, comprising: generating a job information item which is a history data item of a job; storing the job information item into the first storage area and the second storage area; and storing periodically the job information item stored in the second storage area into the second storage section.

Preferably, the management method of job information further comprises displaying selectively one of the job information item stored in the first storage area and the job information item stored in the second storage section on a display section.

The present U.S. patent application claims a priority under the Paris Convention of Japanese patent application No. filed on Jun. 7, 2007 which shall be a basis of correction of an incorrect translation.

Although various exemplary embodiments have been shown and described, the invention is not limited to the embodiments shown. Therefore, the scope of the invention is intended to be limited solely by the scope of the claims that follow.

What is claimed is:

1. An image forming apparatus, comprising:
a first storage section to store a job information item of a job whose execution has been completed;
a nonvolatile second storage section having a larger capacity for storing the job information item than the first storage section; and
a control section to store the job information item into the first storage section and the second storage section to manage the job information item.

2. The image forming apparatus of claim 1, wherein
the first storage section has a higher speed of writing and reading the job information item than the second storage section, and includes a first storage area to store the job information item and a second storage area capable of storing a predetermined number of job information items to be stored into the second storage section, and
the control section periodically stores one or more job information items stored in the second storage area into the second storage section.

3. The image forming apparatus of claim 2, further comprising:
a display section to display the one or more job information items; and
an input section to accept an instruction for displaying the one or more job information items stored in the second storage section on the display section, wherein
when the input section accepts the instruction for displaying the one or more job information items stored in the second storage section, the control section reads out the one or more job information items stored in the second storage section, stores the one or more job information items into the first storage area, and controls the display section to display the one or more job information items stored in the first storage area.

4. The image forming apparatus of claim 3, wherein
when the input section accepts the instruction for displaying the one or more job information items stored in the second storage section, the control section stores the one or more job information items stored in the second storage area into the second storage section, stores the number N of job information items stored in the first storage area, and then reads out the one or more job information items stored in the second storage section, and
when display of the one or more job information items stored in the second storage section is finished, the control section stores N job information items, which are read out from latest job information items out of the one or more job information items stored in the second storage section, into the first storage area.

5. The image forming apparatus of claim 1, wherein the one or more job information items include at least one of the number of pages of a job, a job result indicating whether the job is properly executed or not and a time at which the job is executed.

6. The image forming apparatus of claim 1, further comprising a switching section to switch between displaying one or more job information items stored in the first storage section and displaying one or more job information items stored in the second storage section on the display section.

7. A management method of job information in an image forming apparatus including a first storage section having a first storage area and a second storage area and a nonvolatile second storage section having a larger capacity than the first storage section,
the management method, comprising:
generating a job information item which is a history data item of a job;
storing the job information item into the first storage area and the second storage area; and
storing periodically the job information item stored in the second storage area into the second storage section.

8. The management method of job information of claim 7, further comprising displaying selectively one of the job information item stored in the first storage area and the job information item stored in the second storage section on a display section.
